(19) United States
(12) Patent Application Publication
(10) Pub. No.: US 2013/0018734 A1
(43) Pub. Date: Jan. 17, 2013

(54) Method and Apparatus for Displaying Advertising and Other Information in Classrooms and Other Locations

(71) Applicant: Ryan Tucker Perret, Lafayette, LA (US)

(72) Inventor: Ryan Tucker Perret, Lafayette, LA (US)

(21) Appl. No.: 13/549,015

(22) Filed: Jul. 13, 2012

Related U.S. Application Data
(60) Provisional application No. 61/507,398, filed on Jul. 13, 2011.

(51) Int. Cl. G06Q 30/02

(52) U.S. Cl. 705/14.73

(57) ABSTRACT

A method of combining information about student enrollment in classes and student behavior, to be targeted as an audience for the display of advertisements and other information. Advertisement slots may be sold, either for a predetermined price or in connection with an online auction format, Advertisements can be displayed using multiple modes of communication—including, but not limited to, projection within classroom, via the Internet or through a mobile device. Advertisers can to “bid” on advertising space in “real-time” thus creating an instantaneous marketplace for targeted delivery of advertisements or other information to targeted groups of students.

### CROSS REFERENCES TO RELATED APPLICATION

PRIORITY OF U.S. PROVISIONAL PATENT APPLICATION SER. NO. 61/507,398, FILED JUL. 13, 2011, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains for a method and apparatus for displaying advertising in classrooms and other environments. More particularly, the present invention pertains to a method and apparatus for displaying advertising and other information including, without limitation, through the sale of targeted advertising in classrooms and other environments.

2. Brief Description of the Prior Art

Advertising in classrooms and other academic environments has historically been underutilized. Many classrooms are equipped with technology to project images—including images from a connected computer or processor device—onto a projection screen, monitor or other device or surface. In many cases, devices within classrooms remain powered up and/or in use virtually continuously, including during periods between classes when students are entering and leaving a classroom.

Devices within classrooms and other environments may be controlled remotely including, without limitation, via the Internet. For obvious reasons, advertising materials are typically not displayed in a classroom or other similar facility when instruction is being provided. However, advertising can be displayed within a classroom during the periods prior to the start of a class and after a class has ended, as well as any other period(s) when instruction is not being provided. The audience—typically students—is captive within said classroom or other similar environment with very little outside stimuli; as such, the audience is much more likely to pay greater attention to the advertising or other information displayed than in other settings.

Much information is typically known about each particular class or other audience, thereby permitting display of advertising materials or other information in a targeted manner. For example, the following information is usually known regarding each class: ages of students, class time(s), subject matter covered, and class location. Further, today's classroom is no longer limited to physical space; many classrooms are online, mobile, and go with students in the form of smart phones, computers and other mobile electronic devices.

No marketplace or other mechanism exists for selective display of advertising or other delivery of content to students based on their attendance in a classroom or other similar environment. Further, no platform currently exists on which an advertiser or other party can decide—often very quickly or in real time—whether to deliver a particular advertisement or other content to a group of students, let alone how much they are willing to spend in order to deliver such advertisement or other content.

Thus, there is a need for a means for providing advertising or other information to students and/or other individuals in a classroom or other similar environment. Information regarding a particular audience can be used to specifically tailor content and delivery of such advertising or other information. Further, a system should be provided to permit bidding on such advertising or display means in a competitive manner. Such advertising or information could originate from virtually any source such as, for example, businesses, agencies or groups that seek to promote some idea, cause or solicitation to a group of individuals. Further, such advertisements or other information can include, without limitation, solicitations from online retailers, startup websites seeking traffic, apartment rentals, movie promotions, car dealerships offering incentives, employment, restaurants, bars, airlines, news providers, public service announcements, political candidates or booksellers.

SUMMARY OF THE PRESENT INVENTION

The present invention comprises a method and apparatus for controlling delivery of content including, without limitation, advertising, to targeted audiences in classrooms and/or other similar environments. Specifically, the method of the present invention utilizes information obtained regarding the target audience(s) to specifically tailor the advertising or other content being delivered to such audience(s). For example, in the classroom context, information can be compiled from student applications and registrations and other known data sources regarding student enrollment and behavior.

More specifically, the present invention comprises a system that allows advertisers or other parties to target delivery of an advertisement or other information to specific groups of students. In the preferred embodiment, the present invention employs an online auction format employing a bidding system permitting an advertiser to place bids, and thereafter select advertisement(s) or other content to be projected to targeted individuals via any number of different media options. An advertiser may decide on the mode in which an advertisement or other content is placed, the time that it is placed, and how much the advertiser is willing to spend in order to do so. The system further provides an auction place for bidding on such communication opportunities, while providing the advertiser with specific demographic data about the audience to whom such advertising or other content is directed.

As used herein, the following terms have the following meanings:

Student

An individual to whom advertising is displayed in accordance with the present invention. A Student may or may not be enrolled in an institution of learning. In certain embodiments of the present invention, Students may validate participation in the method of present invention (in the form of an email address, a student ID number, or similar identifying factor), and can often elect to receive certain advertising content.

Class

Class refers to any group of Students that are enrolled in or otherwise share a connection to common institution. The form of advertising content delivered to Student in a Class may not specifically be a classroom, but may include other activities. For example, Students who may be attending a collegiate sporting event could constitute a “Class”, and may be able to view certain advertising or other information during said event.

Institution

An Institution is any establishment or organization in which Students are enrolled and participate in Classes, either physically or virtually (online), including—but not limited to—a university, college, vocational school, technical school, or professional school.

Advertiser

An Advertiser is an entity (typically, but not always, a purveyor of goods and/or services) that chooses to deliver content to Students in any form. In accordance with the present invention, an Advertiser may elect to bid on certain advertising space or other means of delivery of such content. As such, an Advertiser may choose to bid on delivering advertising to a focused group of Students, or to a wide range of Students in many disciplines, at many different times. It is to be observed that an Advertiser is not limited to a business; Advertisers may include government entities, Institutions or other parties.

Classroom

A Classroom is any physical or virtual “space” that a student may enter, attend, be a member of, or be enrolled in. As used herein, a Classroom is not necessarily limited to areas in which instruction or teaching is performed. A Classroom may include, without limitation, a stadium, gymnasium, an office building, or a club meeting location. In certain instances, confirmation of attendance by a Student is beneficial because it refines and provides information regarding Student behavior and a target audience.

Advertising Budget

An Advertising Budget is a value or amount pre-applied by an Advertiser toward future advertisements or other messages to be displayed. An Advertiser can submit payment, typically in advance, in exchange for future bidding opportunities. In cases where an Advertiser has insufficient funds to cover a particular Advertising Budget, credit may be optionally extended, and interest may be charged on such credited amount.

Bidding Platform

A Bidding Platform is an Internet-based online display interface that allows Advertisers to evaluate and select information pertinent to the delivery of advertising content or other information to target audience(s). In the preferred embodiment, the Bidding Platform is a web-based portal that allows Advertisers to select available time(s) and delivery means, as well as current pricing for such options in accordance with the present invention. An Advertiser can perform various tasks including, without limitation, vary bid(s) at particular location(s) and monitor Advertising Budget(s). Typically, a Bidding Platform will not allow Advertisers to see the identity of other Advertisers, but only the current bid amount for certain time slots or other parameters.

Media

Media are conduits or mechanisms for conveying content from an Advertiser to Student(s). Media may include, but is not limited to, a monitor in a Classroom, a projection onto a visible surface within a Classroom, a mobile device such as a smart phone, tablet pc, reading device, audio device, or computer, especially those capable of accessing the Internet. The use of different Media permits differentiated markets in which Advertisers can choose how, when and where to display content.

Projector

A Projector is a device used within a Classroom to project or display advertisements or other information to Students enrolled in a Class. In the preferred embodiment, a Projector can be remotely monitored and controlled to ensure that information is presented in a fashion that is both acceptable to an Institution and Advertiser.

Impression

An Impression includes any form of measurable information delivered to a Student. An Impression may be measured in many ways, including but not limited to a single Still image displayed to a Student, or a video clip, audio clip or combination thereof. Should the same Still image be displayed at a later time, this would be considered a separate Impression. Similarly, a separate Impression would include display on a separate Media. Impressions can be used as a tool of measurement for statistical purposes in order to account for the number of times information is displayed.

Still

A Still is a single image, with or without video or audio element, that is displayed to a Student for a particular period of time. Typically, a Still refers to a single image, displayed for a short period of time that may be modified, conjoined or added to one or more others to create a cohesive message or content.

Passing Notes

Slang for identifying an advertisement or other content that recipients recommend for sharing with other Students. Should an advertisement or other content be viewed, enjoyed, or appreciated, a Student may “pass a note” indicating that another Student may benefit from, appreciate or enjoy the advertisement or information.

Grading System (A+, B, C, D)

A means for grading or ranking advertisements or other information by recipients. For example, an advertisement or other information that receives a “thumbs up” from a predetermined number of Students could receive an “A+” rating. With this grading system, advertisements or other content can be propagated or eliminated based on the opinions of the recipients.

Archive

When a Student signs a roll sheet or otherwise confirms attendance in a Class, the Student may view advertisements in real-time, just before or after class. When Student signs in to the Class on a mobile device or computer, the Student will also have the opportunity to view prior Advertisements or other content, and in some cases Advertisements or content from previous days. This collection of past Advertisements or other content can be electronically stored in accordance with the present invention and can be referred to as the Archive.

Attendance

Attendance is a confirmation that a Student is present, either in a physical or virtual Classroom. Such information can be used to differentiate Advertisements or other content displayed to one group of Students as opposed to another group of Students, as well as the means for displaying such Advertisements or other content. Similarly, “Signing the Roll” is virtual validation that a Student is a member of a particular Class to which Advertising or other content is being targeted.

Advertiser Dashboard

A management tool used by an Advertiser or other party to upload content to the server(s) of the present method, monitor what content is being displayed and approved, and select or bid on different display opportunities.

Student Dashboard

A tool that enables a Student to respond to Advertisements or other content in real-time, assign grades, receive and archive coupons and deal vouchers, review previous Advertisements or other content stored in the Archive, sign the Roll for Class, and track both personal and Class-wide statistics.

Proxy Bidding

A feature that permits an Advertiser to simply input a maximum amount that the Advertiser is willing to spend, over a given time period. A processor of the present invention using programmed logic or specific commands automatically generates bid(s) when desired. Alternatively, when bidding for a single slot, an Advertiser can adjust the highest bid above a preset bid amount so that a Proxy Bid will automatically adjust that Advertiser's bid upward. If an Advertiser's maximum bid level is exceeded during the bidding process, the Advertiser may be notified and given an opportunity to increase said maximum bid level, or notified of alternative spots available.

Queue

A Queue is an order in which Advertisements or other information is displayed in a particular time frame to a particular group. A Queue can be adjusted, and may range in number depending on the length of the different slots available.

Based on any number of measurable variables including, without limitation, the identity of an Institution, the subject matter of a Class, the location of a Classroom (be it physical or virtual) or the number and type of Students enrolled, Advertisers may choose to display advertisements or other information to Students via multiple modes of communication—including, but not limited to, a projector within a Classroom, a webpage display or a mobile device. In the preferred embodiment, an Advertiser can select where an advertisement is to be displayed, time duration of such display, and to whom it is displayed, all based on measured criteria. Further, an Advertiser will have the ability to “bid” on advertising space in “real-time” thus creating an instantaneous marketplace for time and space display Advertisements or other content to Students.

In a preferred embodiment of the present invention, Students can choose to accept Advertisements or other information through personal devices (computers, smart phones, tablets or the like). Students can also view Advertisements and other information displayed directly within a Classroom. In many instances, Students benefit from deals offered, specials presented, and the ability to provide feedback through the system of the present invention. Further, when providing feedback (such as, for example, voting for a favorite advertisement or responding to a question), Students may receive coupons, special offers or other benefits. An Advertiser can also specifically tailor advertising or other information delivered to Students, whether physically displayed in a Classroom, or delivered via computer, smart phone or other electronic device.

Advertisers using the system of the present invention are given a view into the Classroom; that is, Advertisers can determine exactly who is supposed to be in attendance in a particular Class and what they are there to learn, as well as other valuable information. Institutions benefit from the present invention by reaching not only Students enrolled in that Institution, but also Students enrolled at other Institutions. Students can provide feedback, partake in competition between Students and Institutions, and benefit from advertisements or other information displayed using the present invention.

The system of the present invention also allows Advertisers to direct specific content or other information to particular Students based on information obtained from the Classroom. For example, an Advertiser can monitor Student location, field of study, Class times and other information relevant to a particular Student. An Advertiser will have control over what Advertisement or other information is displayed, and can tailor such adverting or information displayed by any number of measurable variable including, without limitation, by Institution, Class time, size, location, or subject. Further, information can frequently be targeted in real time. Advertisers and Institutions can also get immediate feedback from Students viewing an advertisement or other information.

Advertisers can easily and quickly manage their advertisements or other information to be displayed using the functionality of the present invention. Further, Advertisers can track critical information such as, for example, what has been advertised, when, where, and the amount spent on such advertising effort. Advertisers will also be privy to buying patterns of Students exposed to successful advertising efforts.

The present invention brings together Students, Institutions, and Advertisers though a coordinated system for controlling when and how Advertisements or other information is displayed to Students. The invention provides a mechanism for managing delivery, cost and effectiveness of such Advertisements or other information, as well as supply and demand for particular advertising opportunities.

In the preferred embodiment, the present invention also comprises a billing system for accounting for payments from Advertisers (who may be optionally pre-approved), as well as the deduction from prepayments. Funds can be received and accounted for within this billing system before being distributed to Institutions or other parties.

For Institutions having an existing relationship with certain Advertisers, the system of the present invention creates a new revenue stream. Institutions can benefit from such additional source of revenue, as well as immediate feedback from Students exposed to such advertising or other information.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a schematic view of certain components of the present invention.

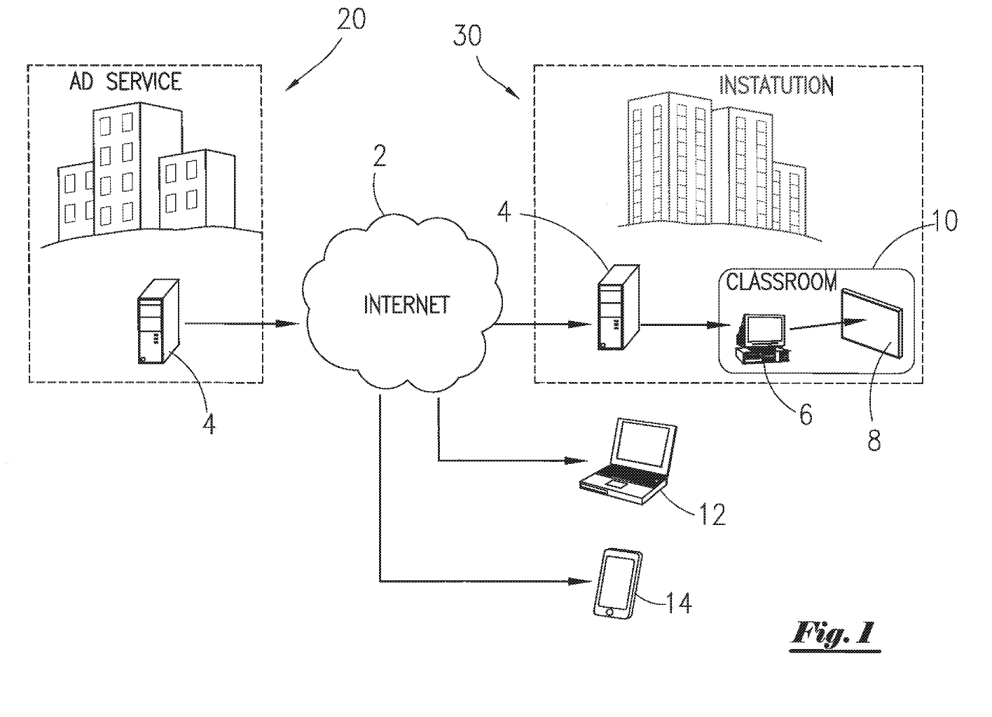

FIG. 2 depicts a schematic view of computer architecture in accordance with one embodiment of the present invention.

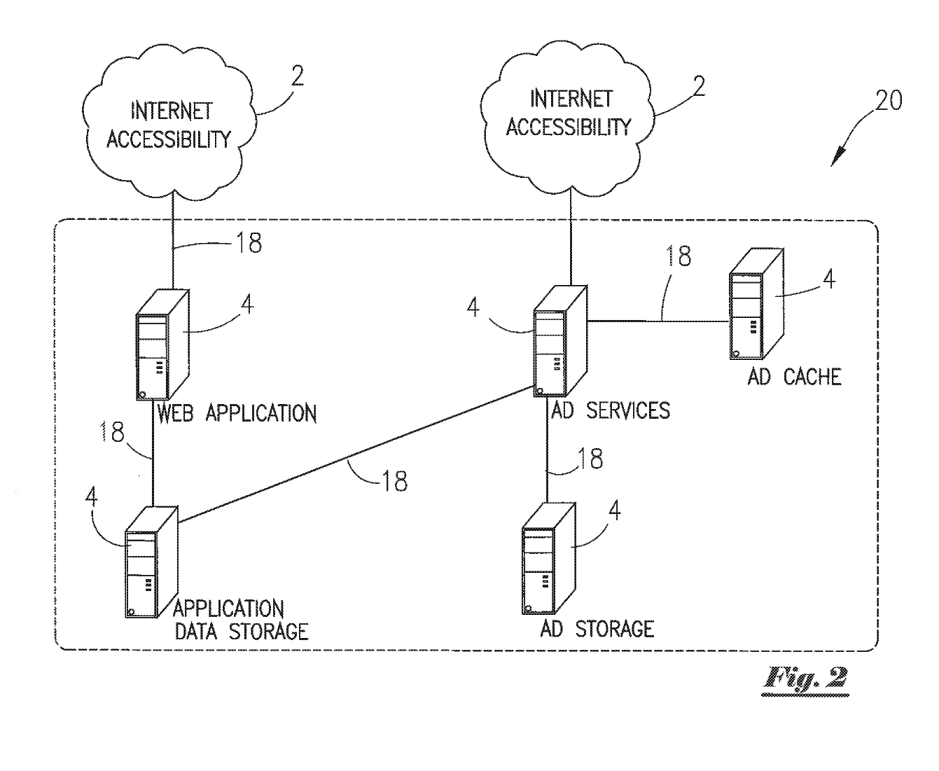

FIG. 3 depicts a schematic view of Institution architecture in accordance with one embodiment of the present invention.

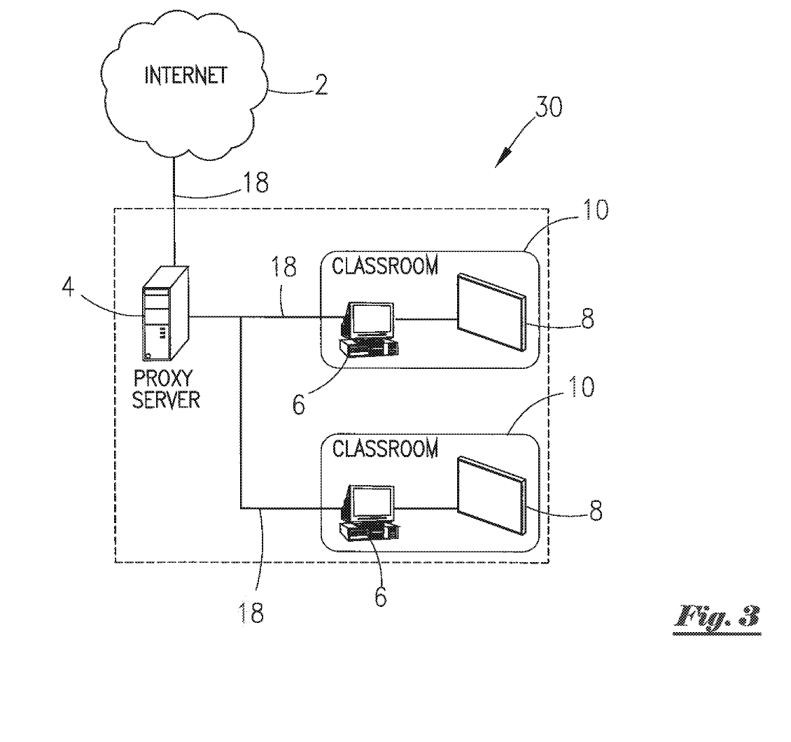

### DETAILED DESCRIPTION OF A PREFERRED EMBODIMENT OF THE INVENTION

The present invention comprises a system that allows preapproved advertisements to be displayed in accordance herewith. Generally, in a preferred embodiment of the present invention, Advertisers are pre-approved. This includes (but is not necessarily limited to) registering as an Advertiser, undergoing a credit/background check, prepaying for future advertising, and/or providing other information as may be required by participating Institutions and/or the system administrator of the present invention.

Typically, an Advertiser will either: 1) submit an Advertisement or other information prior to display to ensure that it is appropriate and approved, or 2) be pre-approved for Advertisements and other content. Once an Advertiser's particular Advertisement or other content has been approved, such Advertisement or other information can be consolidated, tagged, and cataloged in order to be easily accessible, including in certain circumstances from an Archive. Although not necessarily required in all cases, it is contemplated that Advertisements or other content or information will exist in digital format.

After all registration and pre-approved requirements have been satisfied, an Advertiser will be granted limited access to a computer-based network system in accordance with the present invention. In the preferred embodiment, the Advertiser is granted such access, but typically not to the entire network. Such network employs various interconnected servers and computer processors that run proprietary software applications to facilitate functionality of the system of the present invention as more fully described herein. A system administrator will generally have control over said network.

When an Advertiser elects to display an Advertisement or other information the Advertiser can log onto said network. Said Advertiser may choose the medium on which the Advertisement or information will be placed, and will typically also have the option of projecting an Advertisement within Classrooms, on website(s) or mobile devices, or a combination of all available mediums.

In the event that an Advertiser chooses to place an Advertisement, the Advertiser may view a schedule of Classes/events around which Advertisement or other information may be placed. The computer software application of the present invention tracks and provides data regarding enrolled Students (both those registered for Class, as well as statistics on how many typically “Sign the Roll”), as well as the available time and location slots available for displaying Advertisements and makes such information accessible to Advertisers (typically through a web-based interface).

In accordance with the present invention, a default monetary value can be assigned for each slot said value may be adjusted based on different variables including, without limitation, demand for that particular time or area. By way of illustration, an Advertiser may determine that there is a Class offered at a particular time, at Institution X, with 45 students enrolled, at the freshman level in the subject of Theology. Because Advertisements will be shown both prior to, and after classes, the Advertiser may choose a time slot with a designated value of $1.00, perhaps the third of ten available advertising slots before Class.

Assuming that there are ten Advertisers, each willing to pay $1.00 for a slot before Class, then the value for each slot would most likely remain unchanged. However, if greater than ten Advertisers are seeking to place Advertisements or other information in said ten slots, then the price for certain of said slots would likely increase. Further, it is to be observed that the sequential order of the Advertisement slots may also affect bid prices. For example, the last Advertisement displayed immediately prior to the start of a Class means that Students have had the greatest amount of time to “Sign the Roll” and are most likely present to view an Advertisement. Accordingly, the value for that particular slot (i.e., immediately before the start of Class) will likely increase during the bidding process.

In one embodiment of the present invention, in the event that an Advertiser determines that all available slots for a particular Class and time are already taken, the Advertiser may choose to increase the bid amount, which can be accomplished simply by clicking the “BID” button corresponding to a time slot, and entering a higher price for that slot on the Advertiser's network interface screen.

Alternatively, the Advertiser may choose to create a “Marketing Budget”—an amount from which the Advertiser may commit to placement of Advertisements on a recurring (e.g., daily, weekly, monthly basis). In order to accomplish this, the present invention supposes a number of predetermined queries to allow an Advertiser to direct its Advertisements or other information specifically, or generally, to a group of Students. Once those presets are in place, the method of the present invention will auto fill slots available for Advertising without requiring the Advertiser to manually increase bids or place Advertising.

Additionally, some Advertisers will not want to manually adjust their bids for Advertising to specific Students each time that a higher bid is placed. In a proxy fashion, the Advertiser may set a minimum and maximum bid for a particular slot and can choose to be notified only under certain circumstances, such as when their maximum bid has been exceeded.

The present invention allows Students to view Advertisements. In the preferred embodiment, the targeted audience is limited to Students because such Students typically have a means of identifying themselves as Students enrolled within an Institution (e.g. an email address, a school ID, or valid school schedule). Once admitted, Students will optionally be able to view Advertisements or other information displayed in a Classroom, on one or more participating web site(s) and/or on smart phones or mobile devices (optionally through a dedicated “app”),

A Student may also track Advertisements or other information displayed in accordance with the present invention. As each Class nears its scheduled time, a Student may “Sign the Roll” to indicate attendance in said Class. In one embodiment of the present invention, attendance in said Class only permits a Student to view Advertisements or other information displayed during the time period prior to, and after, a designated Class schedule.

Following display of an Advertisement or other information, said Advertisement or other information can be archived so that it can be retrieved by a Student; this can be particularly significant when an Advertisement or other information contains a promotion or offer having an extended expiration (e.g., Student has a period of time to redeem a coupon or take other action to receive a discount or other benefit). However, other Advertisements may be time sensitive and will not be viewable after they are initially displayed. In most cases, Advertisements or other information (whether displayed in real time or archived) will not be displayed or otherwise available during Class periods.

Students can build credits by responding to certain Advertisements or other information, making purchases, and/or attending Class regularly. Such action can be used to create priority between Advertisers who can then optionally deliver additional benefit to Students who patronize said Advertisers. With such information, Advertisers can then choose to specifically tailor Advertisements, offers or incentives to Students meeting certain threshold(s).

The method and apparatus of the present invention also permit Institutions to increase revenue. Information routinely gathered by Institutions can be used by Advertisers to target particular Students with particular Advertisements. Such information can be provided to Advertisers without disclosing personal information about Students. However, Students may voluntarily choose to provide Advertisers with information about themselves and their activities, and Advertisers can frequently confirm this information with information obtained from an Institution.

Additionally, Institutions may limit or define specific advertising parameters or guidelines, and the present invention can preemptively limit Advertisements according to such parameters or guidelines.

It is to be observed that the method and apparatus of the present invention can be modified to fit different requirements or parameters without departing from the scope of the invention described herein. Generally, a representative embodiment of the method of the present invention could comprise the following basic steps:

An Advertiser must first be accepted by participating Institution(s) and the system administrator. It is to be observed that an Institution may approve an Advertiser only for certain means of communicating Advertisements or other information. For example, an Institution may approve an Advertiser for display of Advertisements or other information via smart phones or mobile devices, but not for direct projection display within some or all Classrooms

After an Advertiser has been approved, specific Advertisements or other information provided by said Advertiser may also be made subject to advance approval before being displayed to Students. Typically, this is done by uploading such Advertisement to a server in the form of digital data through an Internet-based upload mechanism well known to those having skill in the art.

After such Advertisements or other information are reviewed and approved by applicable Institution(s) and/or the system administrator, as required, the uploaded Advertisements or other information can be archived on networked servers or other data storage devices, and are typically accessible at the home-screen/Dashboard for the Advertiser. In the preferred embodiment, the Advertiser Dashboard interface permits an Advertiser to retrieve archived Advertisements or other information, and select such Advertisements or other information for display (explained in detail below).

Advertisers may be required to submit prepayment for future advertising activities. The prepaid amount will be maintained on account and drawn upon/debited on an ongoing basis as bids are made by said Advertiser and Advertisements are actually placed. Should an Advertiser seek to bid or otherwise spend more than is available for that Advertiser, the Advertiser may be required to submit additional funds in order to display an advertisement or place a bid. In advance, an Advertiser may also be provided with credit for future advertising expenses when allocated funds are insufficient, with interest being charged on such credit.

If desired, an Advertiser may pre-select group(s) of Students to target with particular advertising or other communication efforts. Data obtained from an Institution and/or directly from Students can be used by Advertisers to specifically define their target audience. Such data can include, without limitation, location of campus(es), Class time, subject being taught, number of students in a Class, divisions within an Institution, and other demographic information; of course, this is not an exhaustive list of all of such available information.

Using the computer interface of the present invention, an Advertiser can view available slots for advertising. Class demographics and other information can be displayed, as well as slots available for bid. In the preferred embodiment of the present invention, an Advertiser can simply drag a preapproved Advertisement from the Advertiser Dashboard, and drop it into a desired advertising slot using the software application of the present invention. An Advertiser can also choose the medium for displaying an Advertisement or other information—including, but not limited to, Classroom projection (via devices connected to or controlled by the system network), online viewer, or a mobile application.

Once a slot and medium are chosen, the Advertiser simply selects a bidding option for the selected slot. At this point, the Advertiser is either the first bidder, in which case they will be charged the starting/default value for such slot. Alternatively, in the event that other Advertiser(s) have selected the same slot, the Advertiser will be able to increase the amount of the bid in order to secure the slot in a competitive auction environment.

Advertisers have the option to increase their maximum bid amount, even though said maximum bid amount may not be shown as the high bid. The “Max Bid” feature of the software of the present invention allows an Advertiser's bid to automatically increase predetermined incremental amount(s) when other Advertiser(s) place a higher bid on the same slot.

Bidding for slots will typically occur up to a predetermined time deadline before the Advertisement or other information is to be displayed; provided, however, that Institutions and the system administrator will have the authority to adjust Advertisements, and prevent or modify their display if desired. In these instances, Advertisers may receive credits that will be added to their Budget.

At a predetermined time prior to the display of an Advertisement, a Queue will be developed. Any slots unsold within a particular Queue may be filled with public service announcements, notifications or communications from the Institution or other information.

As the start of a Class nears, Students attending such Class will be able to view advertisements on display within the Classroom. Students may also sign into a Student Dashboard and view Advertisements or information posted or sent via the software of the present invention on a personal computer or on a mobile device. In the preferred embodiment of the present invention, Advertisements may only be displayed and available to Students who are both enrolled in a Class and who have Signed the Roll to indicate they are actually in attendance.

The system of the present invention can include a network of multiple Institutions such that an Advertiser will be able to display Advertisements or other content at multiple Institutions. Advertisers may choose a single Institution, and perhaps several spots within its schedule, while other Advertisers may desire to reach a broader market across multiple Institutions.

The present invention can also include a method of rewarding frequent Advertisers, such as through discounts, a credit system, or the display of Advertisements during unused or open slots.

The present invention is described herein primarily in connection with the sale and display of commercial advertising. However, it is to be observed that the present invention, and particularly the networked computers and devices thereof, also provide a means for direct communication to Students by an Institution. Thus, it is possible that the present invention can be used for the display of notifications or other communications from the administration of an Institution to its Students or groups thereof.

In one embodiment of the present invention, an Advertiser can use the network interface of the present invention to select various parameters regarding Students and observe resulting then-current pricing for display of desired Advertisements or other information in accordance with such parameters without actually bidding on or purchasing such slots. In this manner, an Advertiser can evaluate how the adjustment of certain variables or demographic input will affect advertising costs prior to actually incurring such costs.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method for displaying advertising to students comprising:
a. Establishing a network having at least one computer server that controls at least one display within at least one classroom;
b. Sending data from said computer server to said at least one display within said classroom; and
c. Controlling the time during which said data is displayed in said at least one classroom.
